(19) United States
(12) Patent Application Publication
(10) Pub. No.: US 2003/0118104 A1
(43) Pub. Date: Jun. 26, 2003

(54) System, method, and software for estimation of motion vectors

(75) Inventor: Andre Zaccarin, Sunnyvale, CA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/032,349

(22) Filed: Dec. 21, 2001

(51) Int. Cl. H04B 1/66; H04N 7/12

(52) U.S. Cl. 375/240.16; 375/240.24; 375/240.12

(57) ABSTRACT

In recent years, it has become increasingly common to transmit sequences of digital images (video data) from one point to another, particularly over computer networks, such as the World-Wide-Web portion of the Internet. To reduce transmission times, computers and other devices that transmit and receive video data often include a video encoder that encodes or compress the data based on the redundancy or similarity between consecutive video frames. Many encoders use motion estimation as a key part of the compression. However, motion estimation itself can be time consuming to perform. Accordingly, the present inventor devised some unique techniques that allow for faster motion estimation. One exemplary technique subsamples a search area of a reference frame to find a set of blocks that have a line of pixels similar to a line of pixels in a target block of another frame. The set of blocks found based on the line similarity are then compared in greater detail to the target block to determine the one best suited for estimating a motion vector for the target block.

### TECHNICAL FIELD

The present invention concerns systems and methods for storing and transmitting sequences of digital images, particularly systems and methods for rapid computation of motion vectors.

### BACKGROUND

In recent years, it has become increasingly common to communicate digital video information—sequences of digital images—from one point to another, particularly over computer networks, such as the World-Wide-Web portion of the Internet. Since a single frame of video can consists of thousands or even hundreds of thousands of bits of information, it can take a considerable amount of time to transmit a sequence of frames from one point to another.

To reduce transmission times and conserve storage space, computers and other devices that use digital video data often include a video compression system. The video compression system typically includes an encoder for compressing digital video data and a decoder for decompressing, or reconstructing, the digital video data from its compressed form.

Video compression typically takes advantage of the redundancy within and between sequential frames of video data to reduce the amount of data ultimately needed to represent the video data. For example, in a one-minute sequence of frames showing a blue stationwagon passing through an intersection of two neighborhood streets, the first 75 percent of the frames in the sequence may only show the intersection itself, nearby houses, and parked cars, and the remaining 25 percent may show the blue stationwagon moving through the intersection. In this case, 75 percent of the frames could be compressed to a single frame plus information about how many times to repeat this frame before showing the frames with the blue stationwagon.

However, even the frames with the blue stationwagon can be compressed given that the background of nearby houses and parked cars remains essentially constant from frame to frame as the stationwagon moves through the intersection. Indeed, conventional video compression techniques would compress the frames showing the blue stationwagon to a set of image data for the blue stationwagon and data indicating position of the stationwagon relative to other portions of the background, such as the streets, houses, and parked cars. The information about relative position of the stationwagon from one frame to the next is generally called a motion or displacement vector.

In general, computing motion vectors is computationally intensive, since unlike the simple example of the blue stationwagon, a video encoder must determine for itself what is redundant or reusable from one frame to the next. Many, if not most, systems determine the motion vectors using a block-matching algorithm.

Block matching entails dividing a given frame into blocks of pixels, and for each block, searching a designated area of the previous frame for the block of pixels that is most similar to it, based on a performance criterion. The location of this “best matching” block relative to the block in the given frame defines a motion vector for the given block. This means that the encoder can represent this block as the location of the “best matching” block from the previously sent frame plus any differences between pixels in the best matching block and those in the block being compressed. Note that if a block in the current frame and a block in the previous frame are identical, such as two blocks that represent the door of a blue station wagon, all differences will be zero and the block in the current frame can be encoded as a coordinate vector identifying the location of the corresponding block in the previous frame plus a code indicating that all differences are zero.

Most of the work in determining a motion vector occurs in comparing each block in the frame being compressed to blocks within the search area of the reference frame. There are numerous ways of comparing one block to another. One common way entails computing the sum of absolute differences between each pixel in the block being encoded and a corresponding pixel in a block of pixels from the search area.

Although the search areas are maybe relatively small compared to the frame size, the number of possible matching blocks within the search area and the use of all the pixels in each of these blocks still requires a significant amount of time to determine a motion vector.

Accordingly, there is a continuing need for faster methods of computing motion vectors.

### BRIEF DESCRIPTION OF THE DRAWINGS

FIG. 1 is a block diagram of a computer system 100 incorporating teachings of the present invention.

FIG. 2 is a flow chart of an exemplary method incorporating teachings of the present invention.

FIG. 3 is a diagram showing a target frame 310, a reference frame 320, and a search area 322.

### DETAILED DESCRIPTION OF EXEMPLARY EMBODIMENTS

The following detailed description, which references and incorporates the above-identified figures, describes and illustrates one or more specific embodiments of the invention. These embodiments, offered not to limit but only to exemplify and teach, are shown and described in sufficient detail to enable those skilled in the art to implement or practice the invention. Thus, where appropriate to avoid obscuring the invention, the description may omit certain information known to those of skill in the art.

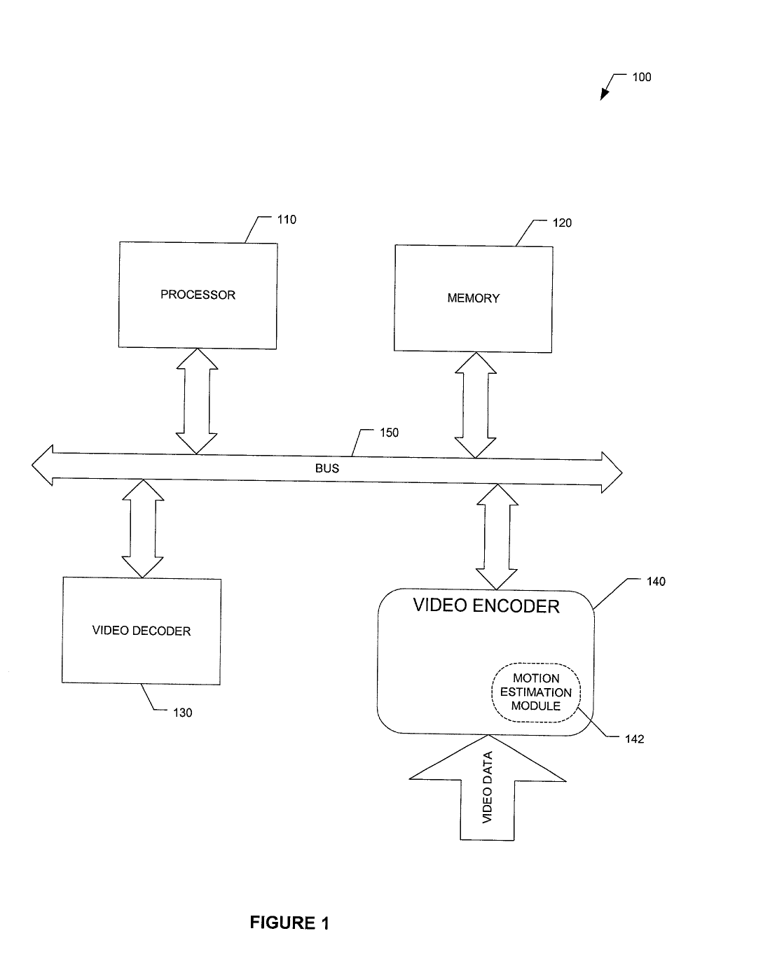

FIG. 1 shows an exemplary video compression system 100. Exemplary system 100 includes one or more processors 110, memory 120, video or image decoder 130, and video or image encoder 140 intercoupled via a wireline or wireless bus 150. (Decoder 130 and encoder 140 are shown as broken-lines boxes to emphasize that they may exist as hardware or software devices.) Exemplary processors include Intel Pentium processors; exemplary memory includes electronic, magnetic, and optical memories; and exemplary busses include ISA, PCI, and NUBUS busses. (Intel and Pentium are trademarks of Intel Corporation, and NUBUS is a trademark of Apple Computer.)

Of particular interest, video encoder 140 includes and a motion estimation module 142. Various embodiments implement module 142 as a set of computer-executable instructions, an application-specific integrated circuit, or as a combination of computer-executable instructions and hardware. (In some embodiments, video encoder 140 includes a separate processor.) Indeed, the scope of the present invention is believed to encompass software, hardware, and firmware implementations.

In general operation, video encoder 140 receives a sequence of video images, or frames, and encodes or compresses them according to one or more intraframe and/or interframe video encoding or compression standards, such as Moving Pictures Experts Group 1, 2, or 4 (MPEG-1, MPEG-2, or MPEG-4), or International Telecommunication Union H.261, H63, or H.263+ Videoconferencing Standards. As part of the otherwise conventional encoding process, motion-estimation module 142 estimates motion vectors for a target block of pixels by subsampling blocks in a search area of a reference frame of video data, measuring distortion based on a subsampling of pixels from the blocks, and using the block with minimum distortion to estimate a motion vector for the target block. The motion vector is then used to encode the target block.

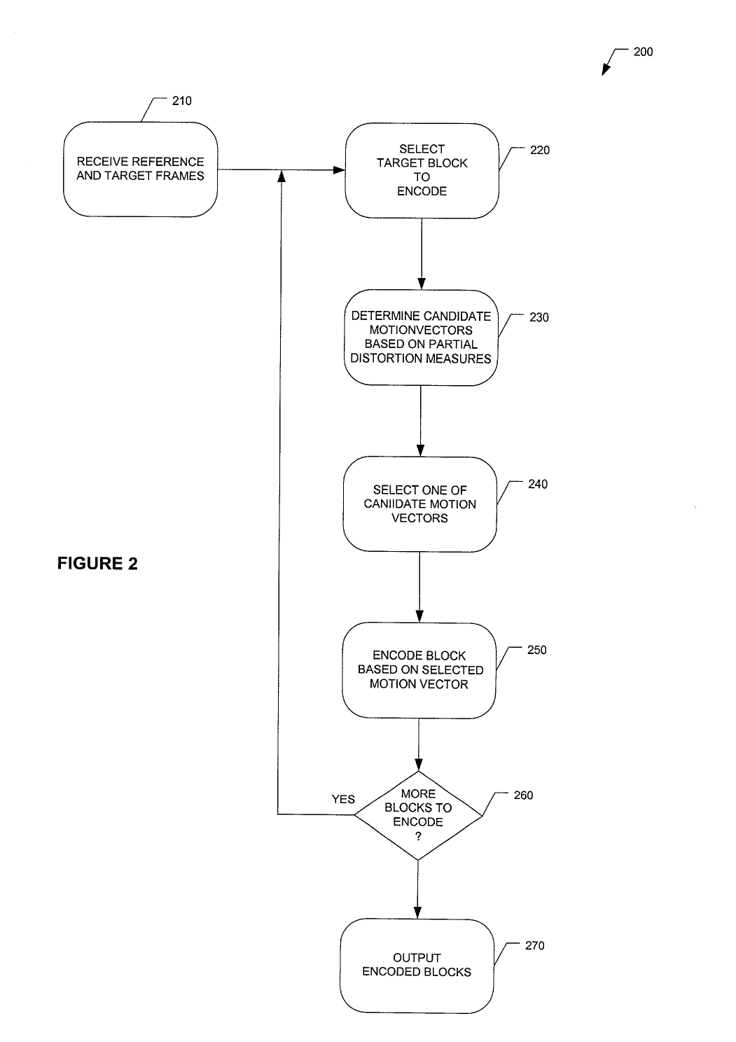

More particularly, FIG. 2 shows a flow chart 200 that illustrates an exemplary method of operating video encoder 140, including a method of estimating motion vectors. Flow chart 200 includes blocks 210-270, which are arranged serially in the exemplary embodiment. However, other embodiments of the invention may execute two or more blocks in parallel using multiple processors or a single processor organized as two or more virtual machines or subprocessors. Moreover, still other embodiments implement the blocks as two or more specific interconnected hardware modules with related control and data signals communicated between and through the modules, or as portions of an application-specific integrated circuit. Thus, the exemplary process flow is applicable to software, firmware, and hardware implementations.

Block 210 entails receiving or retrieving an M-by-N reference frame or field Fᵣ and an M-by-N target frame or field Fₜ of a video sequence, or a subsampled version of the frame or field. Frames Fᵣ and Fₜ respectively comprise a number of reference blocks Bᵣ(x, y) and target blocks Bₜ(x, y), each of which includes an m-by-n (m columns×n lines or rows) array of pixels, with the upper left pixel in the block having the coordinates (x, y). (All blocks in this description are assumed to be rectangular and are identified based on their upper left most pixel coordinates; however, the invention is not limited to any block shape or particular convention for defining blocks.)

In the exemplary embodiment, reference frame or field Fᵣ precedes or succeeds target frame Fₜ in a video or image sequence by one or more frames. However, in other embodiments, for example, some that employ intra-frame encoding, reference frame or field is contained within target frame Fᵣ. Exemplary execution continues at block 220.

Block 220 entails identifying a target block Bₜ(x₀,y₀) from target frame Fₜ and defining a corresponding search area within reference frame Fᵣ. The target block is the block that the video encoder will encode. In some embodiment, two or more target blocks and corresponding search areas are selected and defined to facilitate parallel encoding of the target blocks.

Although the present invention is not limited to any particular target-block identification or search-area definition, the exemplary embodiment centers the search area around coordinates in the reference frame that correspond to or approximate center coordinates of the target block within the target frame. However, other embodiments center the search area on coordinates that are likely to correspond to the coordinates of the best matching block, as determined, for example, by the motion vectors of neighboring blocks. Additionally, the exemplary embodiment defines the search area to smaller than the reference frame and larger than the target block.

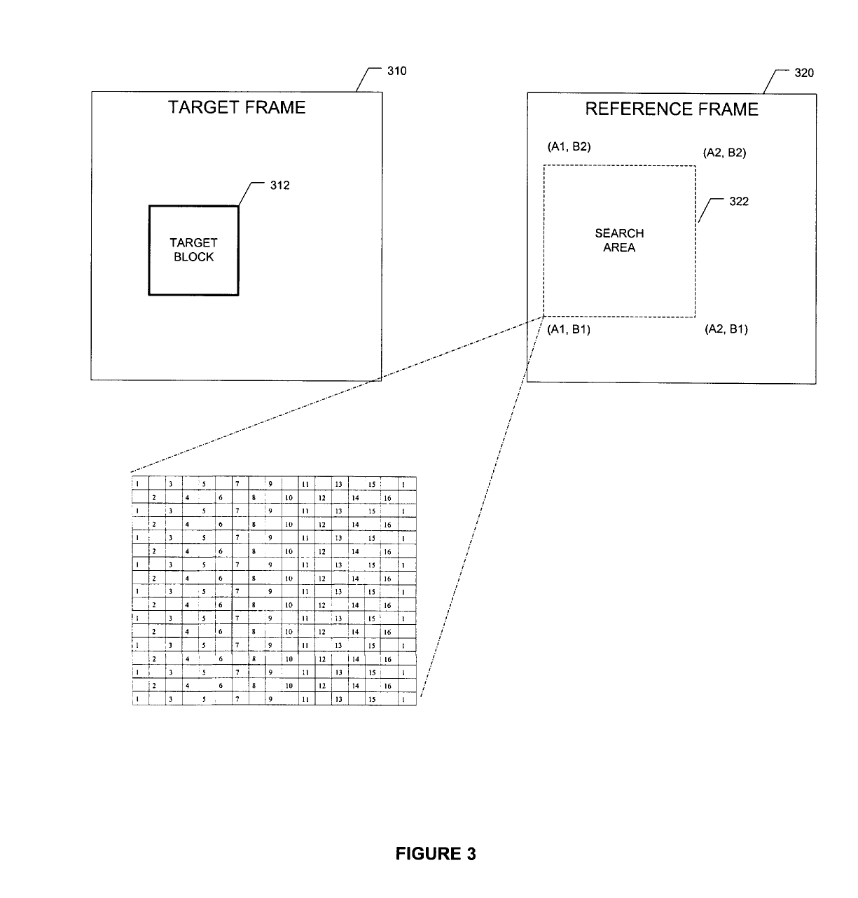

FIG. 3 illustrates a target frame 310 and a reference frame 320. Target frame 310 includes a target block 312, and reference frame 320 includes a search area 322. In the exemplary embodiment, the search area is 15×15 or 31×31 pixels; however, the invention is not limited to these search-area dimensions. The exemplary embodiment defines the search area as the set of upper-left coordinate pixels that define a set of corresponding blocks. However, some other embodiments define the search area in terms of the total set of pixels considered when looking for matching blocks. After identifying one or more target blocks and corresponding search areas, execution proceeds to block 230.

Block 230 entails determining K candidate blocks from reference frame Fᵣ that minimizes a partial distortion measure relative to the selected target block Bₜ(x₀,y₀), with the partial distortion measure based on a predetermined set of pixels in both blocks. If there is a tie among two or more blocks, the first candidate block that yielded the minimum is selected; however, other embodiments may break the tie using other methods, such as minimization of encoding cost.

More precisely, each k-th candidate block in the reference frame is denoted Bᵣ*(aₖ*,bₖ*), where the k-th coordinate pair (aₖ*,bₖ*), or candidate motion vector, is defined as

(aₖ*,bₖ*)=arg min[Dₗ₍ₖ₎(a,b) for (a,b)εSₖ] for k=1 . . . K

Dₗ₍ₖ₎(a,b) denotes a partial-distortion measure based on a k-th set of pixels l(k) within the block Bᵣ(a,b) of the reference frame, and Sₖ denotes a k-th predetermined set of coordinate pairs that defines a particular set of candidate blocks within the search area of the reference frame. Arg min[:] denotes the argument that minimizes the bracketed quantity. In this case, it means the coordinate pair (a,b) within Sₖ that yields the lowest partial-distortion measure.

In the exemplary embodiment, K is 16, and l(k) is defined as the k-th line (or column) of pixels in a given block. Thus, the exemplary embodiment defines 16 mutually exclusive subsampling patterns l(1), l(2), . . . , l(16). However, other embodiments define l(k) as every other pixel in the k-th line, as two or more complete or partial lines within a block. And, still other embodiments define l(k) as a subset of non-collinear pixels within the block.

The exemplary embodiment also defines each set of coordinates Sₖ to contains the coordinates for every other pixel in each k-th column or row of the search area. For example, if the search area is 17×17 and the block size is 16×16, S₁ would contain coordinates identifying every other pixel in the first and seventeenth (17 mod 16=1) columns of the search area, and S₂ would contain coordinates identifying every other pixel in the second column. To further illustrate, FIG. 3 shows a search area with each pixel labeled 1, 2, 3, . . . 16, indicating its respective association with coordinate sets S₁, S₂, S₃, . . . , S₁₆. Alternatively, for an N-column search area and K×K blocks, one can determine the columns for Sᵢ as i, i+K, i+2K, i+3K, and so forth, or as i+nK, for all n≧0 such that i+nK≦N.

Other embodiments use other sizes and shapes of blocks and different levels of search-area subsampling. For example, one embodiment uses a 32×32 pixel search area and defines Sₖ to include every pixel or every fourth, eighth, or sixteenth pixel from each k-th column of the search area.

The exemplary embodiment computes Dₗ₍ₖ₎(a,b) as the Sum of Absolute Differences. More precisely, Dₗ₍ₖ₎(a,b) is defined as

$${D}_{l ( k )} ( a , b ) = {\sum }_{( i , j ) ∈ l ( k )} \vert ( {B}_{t} ( x + i , y + j ) - {B}_{r} ( x - a + i , y - b + j ) \vert$$

However, other embodiments use other distortion-measurement or matching criterion, such as mean absolute difference (MAD) or mean squared error (MSE). Thus, the present invention is believed not to be limited to any particular species or genus of distortion measurement.

The exemplary embodiment uses SIMI (single-instruction-multiple-data) MMX or SSE type instructions, such as the PSAD instruction in the SSE2 instruction set for the Intel Pentium 4 microprocessor, to compute this distortion measure. (Intel and Pentium are trademarks of Intel Corporation.) Use of this type of instruction allows parallel computation of the distortion functions.

Block 240, which is executed after determining the set of K candidate blocks (and associated coordinate vectors) in block 230, entails selecting the vector associated with the block Bₖ*(aₖ*,bₖ*) that minimizes a distortion measure D(a,b). In other words,

(a*,b*)=arg min D(a,b) for (a,b)ε{(aₖ*,bₖ*), k=1, . . . K}

where D(a,b) is defined as

$$D ( a , b ) = {\sum }_{j = 1 i = 1}^{m n} \vert ( {B}_{t} ( {x}_{0} + i , {y}_{0} + j ) - {B}_{r} ( {x}_{0} - a + i , {y}_{0} - b + j ) \vert$$

If more than one block yields the same minimum distortion, there are a number of ways to resolve the tie. For example, the block having the lowest cost of encoding can be selected.

Rather than compute another set of distortion measures based on D, some embodiments simply select the coordinate vector (aₖ*,bₖ*) associated with candidate block Bᵣ*(aₖ*,bₖ*) that yielded the lowest partial-distortion measurement Dₗ₍ₖ₎(a,b). In mathematical terms, this is expressed as

(a*,b*)=arg min[Dₗ₍ₖ₎(aₖ*, bₖ*) for k=1 . . . K]

Again, if there are multiple minima, the exemplary embodiment selects the block that has the lowest encoding cost.

At block 250, after selecting the one of the candidate vectors, the exemplary embodiment encodes block Bₜ of frame Fₜ. This entails computing the motion vector for the target block as

V(xₒ,yₒ)=(a*,b*)

and a difference matrix DM as

DM=Bₜ(x₀,y₀)−Bᵣ(x₀−a*,y₀−b*)

The exemplary embodiment uses this motion vector V and difference matrix DM to encode the target block, specifically forming packets of digital data according to MPEG-1, 2, 4, H.261, H263, H.263+, and/or other suitable protocols.

In decision block 260, the exemplary method determines if the target frame is completely encoded. If it is not fully encoded, meaning that there are additional blocks of the target frame that require encoding, execution returns to process block 220 to initiate selection and encoding of another target block from the target frame. However, if the target frame is fully encoded, execution proceeds to process block 270.

Block 270 entails outputting the packets of encoded data representative of the target frame. The exemplary embodiments outputs the data to a memory for storage and/or transmission to remote display device.

### Conclusion

In furtherance of the art, the present inventor has presented methods, systems, and software for rapid estimation of motion vectors.

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

1. A method of estimating a motion vector for a target block of pixels in a target frame relative to a reference frame, the method comprising:
defining a search area of the reference frame;
defining a plurality of K search sets S₁ . . . S_{K} based on the search area, each search set Sᵢ, for i=1 to K, identifying pixels from an i-th column or row of the search area, with each pixel in each search set identifying a respective block of pixels;
determining a set of K candidate blocks B₁ . . . B_{K}, with each block B₁, for i=1 to K, identified by a pixel in search set S₁ and minimizing a first distortion function relative to the target block, the first distortion function based only on a set of two or more collinear pixels from the target block and a set of two or more collinear pixels from block Bᵢ;
determining which of the K candidate blocks B₁ . . . B_{K} minimizes a second distortion function relative to the target block; and
estimating the motion vector based on the target block and one of the K candidate blocks that minimizes the second distortion function.

2. The method of claim 1:
wherein the search area includes N rows or columns, with N>K; and
wherein each search set Sᵢ only identifies one or more pixels from the i-th row or column and one or more pixels from every (i+nK)-th row or column of the search area, which satisfies: i+nK≦N, for n=1, 2, 3, and so on.

3. The method of claim 1, wherein each pixel in each search set occupies the upper left position of its associated block of pixels.

4. The method of claim 1, wherein each row or column of pixels in the search area consists of a first number of pixels; and wherein each search set Sᵢ identifies less than the first number of pixels.

5. The method of claim 1, wherein the set of two or more collinear pixels from the target block consists of pixels in the i-th row or column of the target block and the set of two or more collinear pixels from block Bᵢ consists of pixels from the i-th row or column of block Bᵢ.

6. The method of claim 1, wherein the plurality of K search sets S₁ . . . S_{K} are mutually exclusive.

7. The method of claim 1, wherein the second distortion function is based on all the pixels of the target block.

8. The method of claim 1, wherein the recited acts are performed in the recited order.

9. The method of claim 1, wherein K is 16 and each block consists of 16 rows or 16 columns.

10. A method of estimating a motion vector for a target block of pixels in a target frame relative to a reference frame, the method comprising:
determining a first plurality of partial distortion measures, each based only on a first row or column of pixels of the target block and a corresponding first row or column in a respective one of a first plurality of blocks in the reference frame, the first plurality of blocks including a first minimum block associated with a minimum of the first plurality of distortion measures;
determining a second plurality of partial distortion measures, each based only on a second row or column of pixels of the target block and a corresponding second row in a respective one of a second plurality of blocks in the reference frame, with the second plurality of blocks including a second minimum block associated with a minimum of the second plurality of distortion measures;
determining a first distortion measure based at least on pixels of the target block and the first minimum block that are outside the first row or column of the target block and the first minimum block;
determining a second distortion measure based at least on pixels of the target block and the second minimum block that are outside the second row or column of the target block; and
determining the motion vector based on the target block and the one of the first and second minimum blocks associated with the lesser of the first and second distortion measures.

11. The method of claim 10:
wherein each first partial-distortion measure is based on all the pixels in the first row of the target block and all the pixels in the corresponding first row of its respective block in the first plurality of blocks;
wherein the first distortion measure is based on all the pixels of the target block and the first minimum block and the second distortion measure is based on all the pixels of the target block and the second minimum block; and
wherein the recited acts are performed in the order recited.

12. The method of claim 10:
wherein each block in the first and second pluralities of blocks is rectangular, and is identified by coordinates of its upper left pixel, with each upper left pixel within a search area of the reference frame, the search area having a plurality of columns of pixels, including at least one first column and at least one second column; and
wherein the upper left pixel of each of the first plurality of blocks is within a first column of the search area, and the upper left pixel of each of the second plurality of blocks is within a second column of the search area.

13. The method of claim 12, wherein each column of the search area consists of N pixels and each of the first and second pluralities of blocks includes less than N blocks.

14. The method of claim 12:
wherein the first and second pluralities of blocks are mutually exclusive; and
wherein the search area includes more than one first column and more than one second column, with the first plurality of blocks including at least one block from each first column and the second plurality of blocks including at least one block from each second column.

15. The method of claim 10, wherein each first partial distortion measure is based on a sum of absolute differences of the pixels in the first row of the target block and pixels in the corresponding first row of its respective block in the first plurality of blocks.

16. An image encoder including a motion estimator for estimating a motion vector for a target block of pixels in a target frame relative to a reference frame, the motion estimator comprising:
means for defining a search area of the reference frame.
means for defining a plurality of K search sets S₁ . . . S_{K} within the search area, each search set Sᵢ, for i=1 to K, identifying pixels from an i-th column of the search area, with each pixel in each search set associated with a block of pixels;
means for determining a set of K candidate blocks B₁ . . . B_{K}, with each block B₁, for i=1 to K, corresponding to one block of pixels associated with a pixel of search set Sᵢ and minimizing a first distortion function relative to the target block, the first distortion function based only on a set of two or more collinear pixels from the target block and a set of two or more collinear pixels from block Bᵢ;
means for determining which one of the K candidate blocks B₁ . . . B_{K} minimizes a second distortion function relative to the target block; and
means for estimating the motion vector based on the target block and the one of the K candidate blocks that minimizes the second distortion function.

17. The image encoder of claim 16, wherein the set of two or more collinear pixels from block Bᵢ comprises two or more pixels from a row of pixels in block Bᵢ.

18. The image encoder of claim 16:
wherein the search area includes N rows or columns, with N>K;
wherein each search set Sᵢ identifies one or more pixels from the i-th row or column and one or more pixels from every (i+nK)-th row or column of the search area, which satisfies:
i+nK≦N, for n=1, 2, 3, and so on; and
wherein the first and second distortion functions are based on a sum of absolute differences.

19. A machine-readable medium for facilitating estimation of a motion vector for a target block of pixels in a target frame relative to a reference frame, the medium comprising instructions for:
defining a search area of the reference frame;
defining a plurality of K search sets S₁ . . . S_{K} within the search area, each search set Sᵢ, for i=1 to K, identifying pixels from an i-th column of the search area, with each pixel in each search set Sᵢ associated with a block of pixels;
determining a set of K candidate blocks B₁ . . . B_{K}, with each block Bᵢ, for i=1 to K, corresponding to one block of pixels associated with a pixel of search set Sᵢ and minimizing a first distortion function relative to the target block, the first distortion function based only on a set of two or more collinear pixels from the target block and a set of two or more collinear pixels from block Bᵢ;
determining which one of the K candidate blocks B₁ . . . B_{K} minimizes a second distortion function relative to the target block; and
estimating the motion vector based on the target block and the one of the K candidate blocks that minimizes the second distortion function.

20. The medium of claim 19, wherein each pixel in each search set occupies the upper left position of its associated block of pixels.

21. The medium of claim 19, wherein each column of pixels in the search area consists of a first number of pixels; and wherein each search set Sᵢ identifies less than the number of pixels in the i-th column.

22. The medium of claim 19, wherein the set of two or more collinear pixels from the target block consists of pixels on the i-th line or row of the target block, and the set of two or more collinear pixels from block Bᵢ consists of pixels on the i-th line or row of block Bᵢ.

23. The medium of claim 19:
wherein the search area includes N rows or columns, with N>K; and
wherein each search set Sᵢ only identifies one or more pixels from the i-th row or column and one or more pixels from every (i+nK)-th row or column of the search area, which satisfies: i+nK≦N, for n=1, 2, 3, and so on.

24. The medium of claim 19, wherein the second distortion function is based on all the pixels of the target block.

25. A system comprising:
at least one processor;
an image decoder coupled to the processor; and
an image encoder coupled to the processor, with the image encoder including a motion estimator for estimating a motion vector for a target block of pixels in a target frame relative to a reference frame, the motion estimator comprising:
means for defining a search area of the reference frame.
means for defining a plurality of K search sets S₁ . . . S_{K} within the search area, each search set Sᵢ, for i=1 to K, identifying pixels from every i-th column of the search area, with each pixel in each search set Sᵢ identifying a block of pixels;
means for determining a set of K candidate blocks B₁ . . . B_{K}, with each block Bᵢ, for i=1 to K, corresponding to one block of pixels identified by a pixel of search set Sᵢ and minimizing a first distortion function relative to the target block, the first distortion function based only on a set of two or more collinear pixels from the target block and a set of two or more collinear pixels from block Bᵢ;
means for determining which one of the K candidate blocks B₁ . . . B_{K} minimizes a second distortion function relative to the target block; and
means for estimating the motion vector based on the target block and the one of the K candidate blocks that minimizes the second distortion function.

26. The image encoder of claim 25, wherein the set of two or more collinear pixels from block Bᵢ comprises two or more pixels from a line of pixels in block B₁.

27. An image encoder including a motion estimator for estimating a motion vector for a target block of pixels in a target frame relative to a reference frame, the motion estimator comprising:
a first minimization module that determines a set of K candidate blocks B₁ . . . B_{K}, with each block Bᵢ, for i=1 to K, minimizing a respective first distortion function relative to the target block, the respective distortion function based only on a set of two or more collinear pixels from the i-th row or column of the target block and a set of two or more collinear pixels from the i-th row or column of block Bᵢ;
a second minimization module that determines which of the K candidate blocks B₁ . . . B_{K} minimizes a second distortion function based at least on pixels outside the i-th row or column of the target block; and
an estimation module that estimates the motion vector based on the target block and one of the K candidate blocks that minimizes the second distortion function.

28. A system comprising:
at least one processor;
an image decoder coupled to the processor; and
the image encoder of claim 27 coupled to the processor.

29. A method of estimating a motion vector for a target block of pixels in a target frame relative to a reference frame, with the target block having two or more lines of pixels, the method comprising:
identifying a set of two or more candidate blocks in the reference frame, with each candidate block minimizing a first distortion function based on only one respective line of pixels of the target block and a corresponding line of pixels in the candidate block, the one respective line being different for each candidate block;
determining which one or more of the candidate blocks minimizes a second distortion function based on pixels from more than two lines of the target block; and
determining the motion vector based on one of the candidate blocks that minimizes the second distortion function.

30. The method of claim 29, wherein each block comprises two or more rows of pixels, and each line of pixels comprises pixels from one respective row of pixels.
